(19) United States
(12) Patent Application Publication
(10) Pub. No.: US 2026/0186577 A1
(43) Pub. Date: Jul. 2, 2026

(54) SENSING SYSTEM AND METHOD FOR SENSING CONTACTLESS DIRECTED USER INPUTS AND METHOD FOR CALIBRATING THE SENSING SYSTEM

(71) Applicant: GESTIGON GMBH, Luebeck (DE)

(72) Inventor: Cornelius Reinfeldt, Luebeck (DE)

(73) Assignee: GESTIGON GMBH, Luebeck (DE)

(21) Appl. No.: 18/868,300

(22) PCT Filed: May 11, 2023
(86) PCT No.: PCT/EP2023/062591

§ 371 Date: Nov. 22, 2024

(30) Foreign Application Priority Data
May 23, 2022 (DE) 10 2022 112 930.6

(51) Int. Cl. G06F 3/01; G06T 7/80; G06V 10/94; G06V 10/98; G06V 20/59; G06V 40/20

(52) U.S. Cl. CPC G06F 3/017; G06T 7/80; G06V 10/945; G06V 10/98; G06V 20/59; G06V 40/20; G06F 3/012; G06F 3/013; G06T 2200/24; G06T 2207/20061; G06T 2207/30196; G06T 2207/30241; G06T 2207/30268

(57) ABSTRACT

A calibration method for calibrating a sensing system for sensing contactless directed user inputs of a user with respect to a user interface (UI) of a target system comprises: receiving or sensor-based generating sensor data which represent a sensorially detected input pattern. Two or more different partial patterns of the input pattern are determined, for each of which: an assigned mathematical mapping rule between two reference systems is determined, by the partial pattern or the recognition pattern is mapped on the basis of the mapping rule so that the partial pattern and the recognition pattern are present in a common reference system. In dependence on a mapping error indicating a measure of a deviation between the partial pattern and the recognition pattern, one of the partial patterns is selected and the mapping rule assigned thereto is defined as a calibration variable for calibrating the sensing system for a subsequent use.

The present invention relates to a sensing system and a method for sensing contactless directed user inputs with respect to a user interface of a target system, a method for calibrating the sensing system, and a computer program or computer program product for carrying out at least one of the above-mentioned methods.

The contactless interaction with a user interface (UI), in particular a graphical user interface (GUI) of a computer or on a computer display screen by hand gestures (e.g., pointing, pulling, grasping gestures, etc. with respect to one or more GUI objects) and eye behavior (e.g., looking at a GUI object, blinking to select, . . . ) is a powerful approach for computer UI concepts, in particular for environments in which the traditional interaction (via keyboard or other touch devices) is not possible.

The concept of such an interaction is based here on the fact that when a user points with the finger at a display screen, the pointing beam (the beam which originates from the hand and extends along the pointing direction) virtually intersects the display screen at a specific point. If this intersection point is interpreted analogously to a touch on a touchscreen, the foundation for contactless display screen control UIs results.

A viewing direction can also be used instead of a pointing direction as the basis for eye-controlled sensing systems. View and gestures can even be combined for more powerful user inputs.

In order to be able to transfer a sensorially detected viewing direction or gesture reliably into a correct user input in practice, however, it is necessary to calibrate the sensor used for detection or any data processing of the raw data supplied from the sensor with respect to the display screen, in particular with respect to its relative location in relation to the sensor. In permanently installed sensing systems, a single calibration is generally sufficient for this purpose, since the relative location normally no longer changes thereafter. In changeable sensing systems, in which the relative location of the sensor in relation to the display screen or another display surface is designed as variable, in contrast, a repeated or even continuous calibration is typically necessary so that subsequent user inputs can again be correctly sensed even if the location has changed.

It is an object of the invention to further improve the calibration of a sensing system for sensing contactless directed user inputs with respect to a user interface of a target system, in particular to enable a reliable correct sensing even if the relative location between the sensing system and the target system or its user interface is variable.

The object is achieved according to the teaching of the independent claims. Various embodiments and developments of the invention are the subject matter of the dependent claims.

A first aspect of the solution presented here relates to a calibration method, which is computer-implemented in particular, for calibrating a sensing system for sensing contactless directed user inputs of a user with respect to a user interface (UI) of a target system, in particular for its control or configuration. The method comprises:
(i) receiving or sensor-based generating sensor data which represent a sensorially detected input pattern with respect to a first reference system assigned to the sensing system, that a user inputs on the basis of at least one contactless directed user input with respect to the UI in order to copy a structure of a predefined recognition pattern visually represented by a display device, such as a display screen, of the UI by means of a spatial course of the user input. A second reference system is assigned here to the display device (in general the first and the second reference system differ from one another at least with respect to their location (i.e. with respect to their position and/or orientation)). The copying of the recognition pattern can in particular be carried out by continuously traveling along or contactless sampling point by point (for example in the sense of sampling) of the recognition pattern;
(ii) determining two or more different partial patterns of the input pattern;
(iii) for each of the partial patterns:
   determining, in particular estimating, a mathematical mapping rule assigned to the partial pattern, in particular homography, between the two reference systems and mapping the partial pattern or the recognition pattern on the basis of the mapping rule so that after the mapping the partial pattern and the recognition pattern are present in a common reference system. The mapping rule can thus define mapping of the first reference system into the second reference system or—alternatively—in the reverse mapping direction, so that the reference system into which the mapping takes place is used at the same time as the common reference system. The recognition pattern can in particular already be previously known to the sensing system or can be received dynamically by the sensing system in the context of the calibration method, for example, via a direct or indirect, in particular at least partially wireless data connection between the target system and the sensing system;
   determining a mapping error which indicates a measure of a deviation between the partial pattern and the recognition pattern in the common reference system; and
   selecting one of the partial patterns in dependence on a comparison of its assigned mapping error to the respective mapping error of at least one other partial pattern; and
(iv) defining the mapping rule assigned to the selected partial pattern as a calibration variable for calibrating the sensing system for a subsequent use for transformation of contactless directed user inputs of the user sensed with respect to the first reference system into user inputs corresponding thereto and related to the second reference system with respect to the UI of the target system.

The sensing system can be configured in particular as a vehicle-based sensing system (for example, as a control unit for a vehicle) for sensing user inputs in a vehicle, while the target system can be configured in particular as a vehicle-external system. The sensing system can in particular be or comprise a program-controlled computer system.

The term “reference system” as used herein is to be understood in particular as an imaginary spatial or space-time formation which is required in order to clearly and completely describe the behavior of location-dependent variables. The reference system, in particular its spatial aspect, can be described in particular on the basis of a defined coordinate system. The first reference system can in particular be defined relative to a vehicle. The second reference system assigned to the display device can in particular be defined so that a plane spanned by two spatial dimensions of the second reference system coincides with a plane of the display device, in particular a planar display screen surface or projection surface of the display device.

The term “partial pattern” as used herein is to be understood in particular as a pattern which at the same time forms a subset of a higher-order pattern, in particular the recognition pattern here. For example, in a grid-like pattern made up of a family of parallel horizontal lines and a family of vertical lines, each of these families can be interpreted individually as a partial pattern of the grid pattern. According to another example, in a polyline composed of a plurality N of linked, in particular straight line segments, in particular one—or even each—subset of M<N, in particular linked line segments can be interpreted as a partial pattern of the overall polyline.

The term “calibration variable” as used herein is to be understood as information, in particular a mapping rule, which at least proportionally defines a specific calibration of the sensing system.

The terms “comprises,” “contains,” “includes,” “has,” “having” or any other variant thereof as may be used herein are intended to cover non-exclusive inclusion. By way of example, a method or a device that comprises or has a list of elements is thus not necessarily limited to those elements, but may include other elements that are not expressly listed or that are inherent in such a method or such a device.

Furthermore, unless expressly stated otherwise, “or” refers to an inclusive or and not to an exclusive “or”. For example, a condition A or B is satisfied by one of the following conditions: A is true (or present) and B is false (or absent), A is false (or absent) and B is true (or present), and both A and B are true (or present).

The terms “a” or “an” as used herein are defined as “one or more”. The terms “another” and “a further” and any other variant thereof should be understood in the sense of “at least one other”.

The term “plurality” as possibly used here should be understood in the sense of “two or more”.

The terms “configured” or “designed” to fulfil a particular function (and any variations thereof) are understood to mean for the purposes of the invention that the corresponding device is already present in a configuration or setting in which it can perform the function or the device is at least adjustable—i.e., configurable—such that it can perform the function after appropriate adjustment. The configuration can be applied, for example, by an appropriate setting of parameters of a process sequence or of switches or similar for activating or deactivating functionalities or settings. In particular, the device may comprise multiple predetermined configurations or operating modes, so that the configuration can be carried out by means of a selection of one of these configurations or operating modes.

The above-mentioned method according to the first aspect enables a suitable calibration of the sensing system with regard to user inputs with respect to the UI of the target system to be achieved, in particular in situations in which the relative spatial location of a sensor used for sensing the sensor data, on the one hand, and the display device or its display area—and thus the relative location of the first and the second reference system in relation to one another—are variable, in particular are not known a priori. Even in such variable situations, a reliable operability of the target system by means of contactless directed user inputs with respect to the UI can thus be achieved.

Such a case can occur in particular if the sensing system is mobile, for example, vehicle-based, while the target system is stationary.

Exemplary embodiments of the method will now be described below, each of which, unless expressly excluded or technically impossible, may be combined as desired with one another and with the further described other aspects of the invention.

In some embodiments, the calibration method is configured or used for calibrating a sensing system arranged in or on a vehicle with respect to a vehicle-external target system in relation to this vehicle. Many different types of systems, in particular infrastructure systems, come into consideration as the target system here, which are suitable or intended for a contactless operation by a user from a vehicle. These include in particular parking management systems such as parking meters, barrier systems, or other access control systems, drive-in terminals or drive-in kiosks, garage doors, or electronic information panels with UI. Since the relative location of the vehicle in relation to a UI of such a target system is naturally typically variable or is not unambiguously known beforehand, the calibration method can be used particularly advantageously here in order to carry out a calibration taking into consideration the relative location of the vehicle or the user executing the interaction with respect to the target system before a desired interaction with the UI so that the following interaction can be sensed correctly reliably.

In some embodiments, the sensor-based generation of sensor data is carried out by means of sensorial detection of a free space gesture, in particular a pointing gesture (for example, via the arm and/or hand) of the user or by means of head or eye tracking. In this way, contactless directed user inputs (in particular on the basis of a measured or estimated viewing direction or pointing direction), which are executable by most people with very high target accuracy, can be enabled as the basis for the calibration method and for the sensing of later interactions of the user with the UI of the target system by means of the calibrated sensing system.

In some embodiments, the input pattern represents a sensorially detected path which a user inputs on the basis of the at least one contactless directed user input with respect to the UI in order, by means of a spatial course of the user input, in particular a “pointing track” or “viewing track” defined by the user input, to copy a structure in the form of a course of a predefined recognition pattern in the form of a polyline visually represented by a display device of the user interface (e.g., display screen or projection device for projecting an image on a projection surface). At least two of the partial patterns of the input pattern each represent a different path section of the overall path in this case. The selection of a linear path as a recognition pattern or input pattern is advantageous in particular in that it can be copied particularly easily even by an unpracticed user in the context of a contactless directed user input of the input pattern and moreover is particularly easy to process in the scope of a data processing function. Such a path can be defined in particular as a linking of multiple straight path segments (polyline), which in particular enables it to be represented efficiently and in a manner that can be easily processed and stored solely by the starting and endpoints of the segments, i.e. the endpoints and corner points (vertices) of the polyline.

In some of these embodiments, the calibration method furthermore comprises smoothing the path before the determination of the path sections as a partial pattern. In this way, in particular any disturbances of the intended spatial course of the user input (“shaky” inputs) occurring during the user input can be corrected in order to reduce or even avoid entirely erroneous interpretations or unnecessarily large amounts of data for representing and processing the path sensed as the input pattern. A more accurate or optimized calibration can thus be achieved on the basis of the smoothest path, which ultimately in turn promotes particularly reliable recognition of user inputs at the UI of the target system by means of the sensing system then calibrated.

The smoothing of the path can comprise according to some embodiments in particular straightening of the path section by section, in which the path is approximated by means of a plurality of segments which are each straight lines. In particular the above-mentioned polyline having the associated advantages can thus be achieved. The straightening section by section of the path can be carried out in particular using a Hough transformation, by which a good approximation of the input pattern by a polyline can be achieved in a particularly robust and reliable manner.

In some embodiments, the first reference system is defined as a first virtual two-dimensional surface or such a surface is defined therein. Moreover, the input pattern is defined on the first virtual surface by a projection of the user input in the form of linear beams following the respective current direction of the directed user input along its spatial course on the first virtual surface. The first virtual surface can in particular be the inner surface of a virtual conical surface or conical partial surface or can be located thereon. It is also conceivable that the first virtual surface is cumulatively composed of multiple separate partial surfaces.

The second reference system is defined as a second virtual surface. The associated mapping rule defines a mapping between the two virtual surfaces for each partial pattern, wherein the one of the surfaces which is used as the target surface of the mapping rule is defined as the common reference system. The use of two-dimensional surfaces in each case, between which the mapping rule defines a transformation, in particular has the advantage of a complexity reduced in relation to the general three-dimensional case. As a result, the calculation of the mapping rule and its application is also simplified, which can also be used for increased efficiency and, with given computing power, for faster, in particular real-time capable implementation of the calibration method and subsequent sensing of user inputs with respect to the UI in the context of interactions with the target system.

In some of these embodiments, the first reference system is defined in dependence on one or more previously detected directed user inputs so that these one or more previously detected user inputs correspond to points and/or lines on the first virtual surface. In other words, this means that the first virtual surface is defined so that these one or more previously detected user inputs “strike” the first virtual surface and do not shoot past it, for example. In this way, the first virtual plane as such can be positioned in a simple manner on the basis of the one or more user inputs in three-dimensional space, in particular so that it is reachable well as a hit surface for directed user inputs executable by the user, for example, if the user is seated belted in on a vehicle seat in the interior of a vehicle and is therefore restricted in their movement freedom and possibly also with respect to the field of vision invisible to them in the vehicle-external area.

In some embodiments, at least one of the two surfaces is defined so that it comprises a virtual plane or a limited surface section thereof. This in particular simplifies the implementation of the determination of the mapping rule and carrying out mapping between the reference systems according to the mapping rule.

In particular, according to some embodiments the first virtual surface can be defined so that it comprises a virtual plane or a limited surface section thereof which is orthogonal to the direction of a previously detected directed user input. A particularly simple and efficient user-controlled definition of the virtual surface, in particular a spatial location of the surface in space can thus be achieved.

In some embodiments, the first virtual surface is defined so that it meets at least one of the following conditions:
(i) it forms a boundary surface which encloses a three-dimensional spatial area on at least two sides;
(ii) it comprises at least two separate partial surfaces which are nonparallel at least in some sections;
(iii) each projection in the form of a linear beam of a directed user input along its respective current direction and through the first virtual surface intersects the first virtual surface in precisely one point.

Option (i) is in particular advantageous in that the solid angle range into which the user can successfully execute their directed user inputs (so that they are sensed) can be expanded, in particular beyond a half space (as would be the case with a first virtual surface in the form of a single virtual plane). Option (ii) can also be used to expand the solid angle range available for user inputs, in particular if user inputs are supposed to be able to take place into solid angle ranges separated from one another (for example, through the windshield of a vehicle and through a side window separated therefrom by a spar). Option (iii) is used in particular to effectively avoid ambiguities in the input from the outset.

In some embodiments, the partial patterns are defined so that they are each represented at least proportionally by a sequence of discrete points on the input pattern, in particular in the case of a path in the input pattern along the course of the respective path section of the path. This permits particularly efficient and fast implementations, which preserve the amount of data in particular, with low computing effort, since the processing of the input pattern can be reduced to calculations with respect to the discrete points (in particular vertices).

In some embodiments, to determine the respective mapping error of a partial pattern, a comparison of the recognition pattern to the partial pattern in the common reference system on the basis of homogeneous coordinates (in the sense of projective geometry) is used to describe the recognition pattern, on the one hand, and the partial pattern, on the other hand. Therefore, due to the use of homogeneous coordinates, a spatial dimension, namely along a direction of the user input (in particular in the pointing direction or viewing direction) can be de facto “compressed” so that multiples of a coordinate value along the spatial dimension coincide with one another upon the transition to homogeneous coordinates and the complexity thus decreases. The advantage of homogeneous coordinates is therefore in particular in the uniform representation of the elements of a projective space in which distant elements (in particular multiples) no longer play a special role. Moreover, due to the use of homogeneous coordinates, all collineations, and therefore also parallel shifts, can be described uniformly by linear mappings and therefore efficiently and well processably by matrices.

A second aspect of the solution proposed here relates to a method for sensing contactless directed user inputs of a user with respect to a user interface (UI) of a target system by means of a sensing system. The method comprises:
(i) calibrating the sensing system according to the calibration method according to the first aspect;
(ii) receiving or sensor-based generating input data which represent a sensorially detected, contactless directed user input of a user with respect to the UI in the first reference system, which can be defined in particular in a vehicle-based manner;
(iii) transforming the input data into output data which represent an input at the UI corresponding to the user input and transformed into the second reference system, using the mapping rule defined in the scope of the calibration method or a mapping rule inverse thereto; and
(iv) transmitting the output data to the target system, which is vehicle-external in particular, in particular for its operation, control, or configuration.

The method according to the second aspect can therefore be used to enable a user input-controlled operation, control, or configuration of the target system after the calibration according to process (i).

A third aspect of the solution presented here relates to a sensing system for sensing contactless directed user inputs of a user with respect to a user interface (UI) of a target system, wherein the sensing system is configured to carry out the calibration method according to the first aspect or the method according to the second aspect.

In some embodiments, the sensing system furthermore comprises a sensor device for sensorially detecting the contactless user inputs and for generating sensor data and/or input data which represent these user inputs in the first reference system. The sensor for detecting the user inputs is therefore already itself part of the sensing system itself, for example, in a form integrated in a housing thereof.

A fourth aspect of the solution presented here relates to a vehicle comprising a sensing system according to the third aspect.

A fifth aspect of the solution presented here relates to a computer program or computer program product, comprising instructions, which, when they are executed on one or more processors of a sensing system according to the third aspect, prompt it to carry out the calibration method according to the first aspect or the method according to the second aspect.

The computer program can, in particular, be stored in a non-volatile data carrier. This is preferably a data carrier in the form of an optical data carrier or a flash memory module. This may be advantageous if the computer program as such is to be handled independently of a processor platform on which the one or more programs are to be run. In another implementation, the computer program can be present as a file on a data processing unit, in particular on a server, and can be downloaded via a data link, for example the Internet or a dedicated data link such as a proprietary or local network. In addition, the computer program can have a plurality of individual interacting program modules. In particular, the modules can be configured to be used, or in any case can be usable in such a way that they are used, in the sense of distributed computing on different devices (computers or processor units) that are geographically remote and connected to one another via a data network.

The sensing system according to the third aspect can correspondingly have a program memory in which the computer program is stored. Alternatively, the sensing system can also be configured to access, via a communication link, a computer program which is available externally, for example on one or more servers or other data processing units, in particular in order to exchange therewith data which are used while the method or computer program is running, or represent outputs of the computer program.

The features and advantages which are explained with respect to the first aspect and second aspect of the solution presented here apply correspondingly also to the further aspects of the solution.

Further advantages, features and application possibilities of the present invention can be found in the following detailed description in conjunction with the figures.

In the Figures:

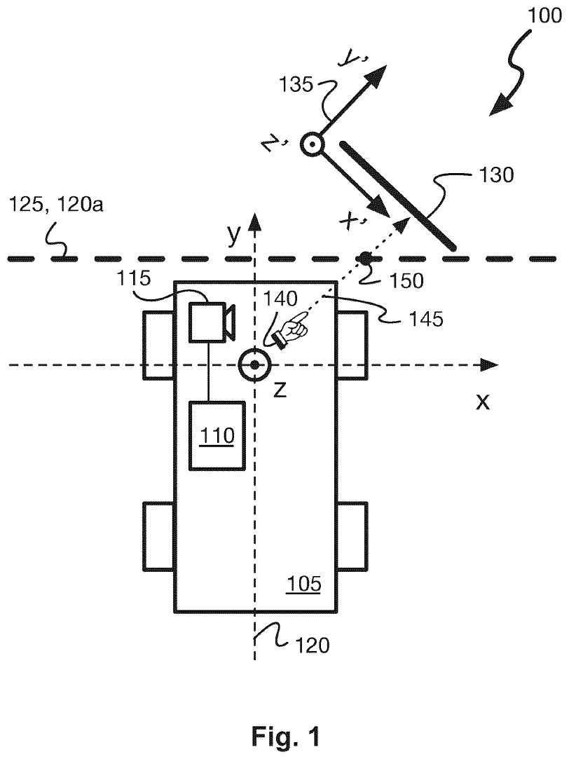

FIG. 1 schematically shows a first exemplary calibration and operation scenario with a first virtual plane;

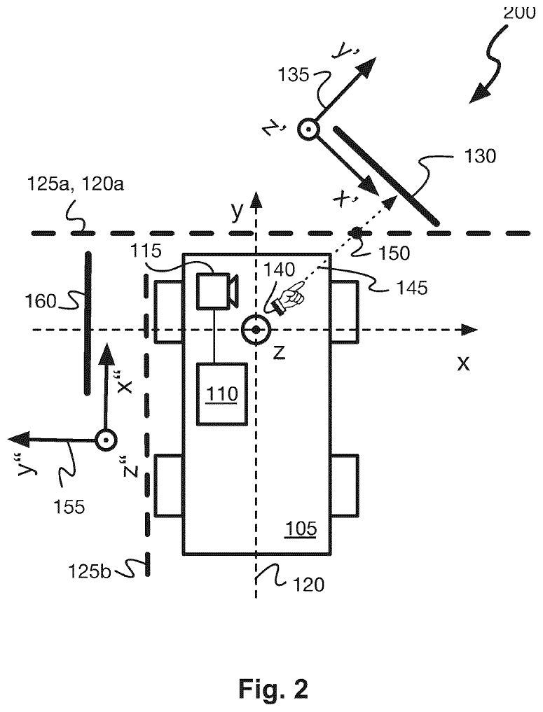

FIG. 2 schematically shows a second exemplary calibration and operation scenario with a first virtual plane and a third virtual plane different therefrom;

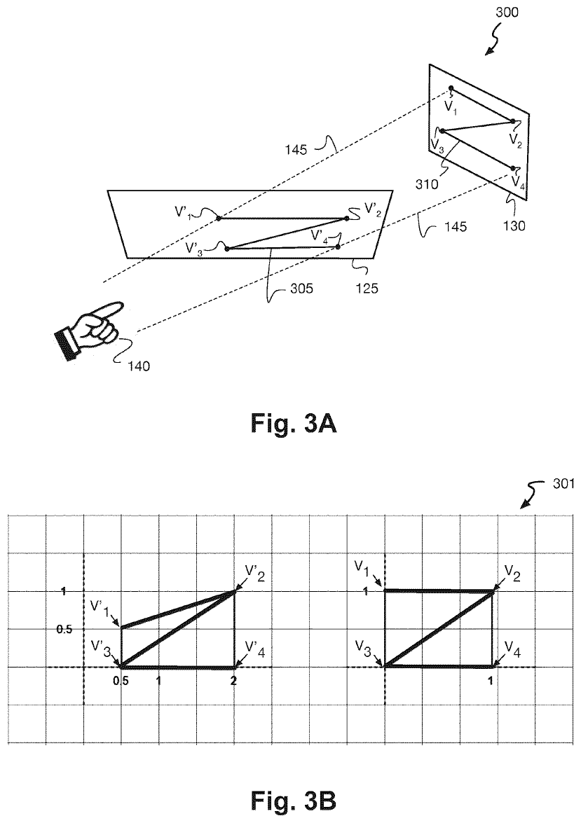

FIG. 3A schematically shows a perspective view of an exemplary spatial relationship of input pattern and recognition pattern;

FIG. 3B once again shows the spatial relationship of input pattern and recognition pattern from FIG. 3A, wherein the two patterns are transferred to a common representation plane here for the purpose of better comparability, however;

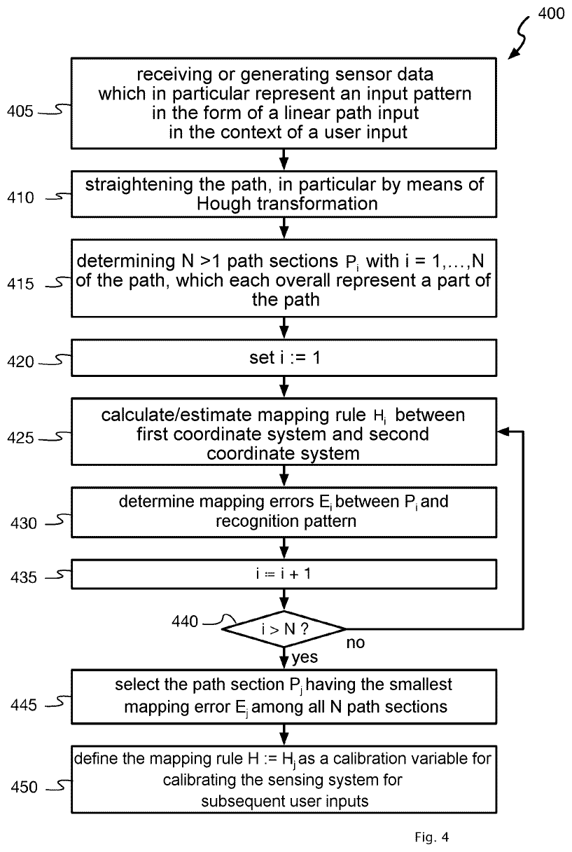

FIG. 4 shows a flow chart to illustrate an exemplary embodiment of the calibration method according to the first aspect;

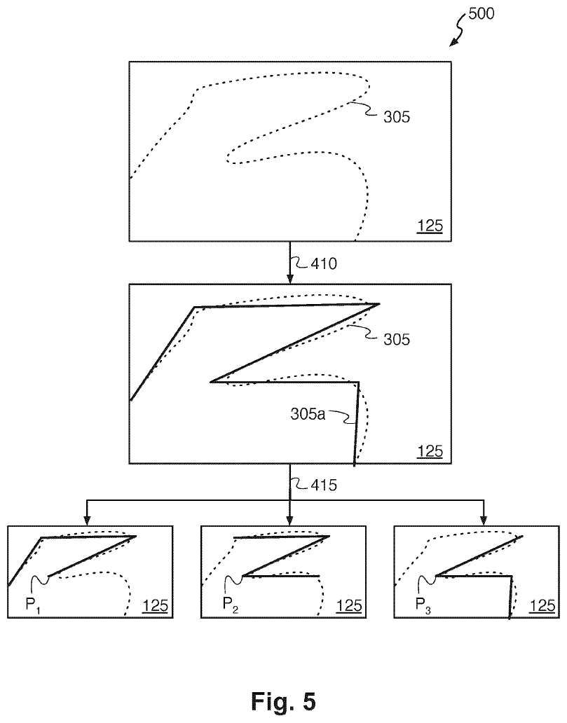

FIG. 5 schematically shows an illustration of a determination of exemplary partial patterns in the context of the calibration method from FIG. 4; and

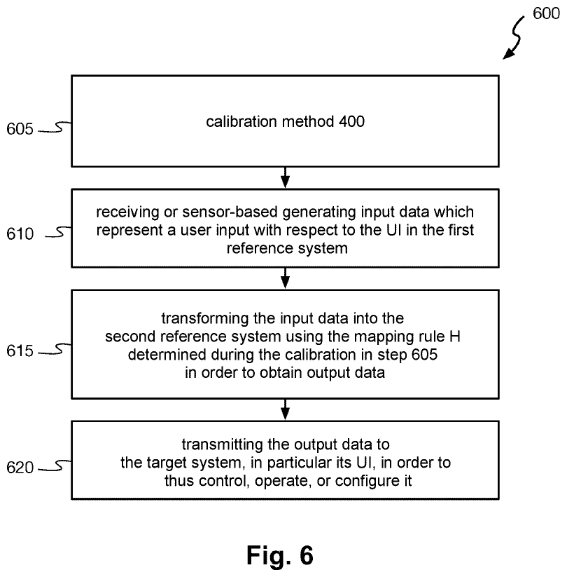

FIG. 6 shows a flow chart to illustrate an exemplary embodiment of the method according to the second aspect for sensing contactless directed user inputs.

In the figures, identical reference signs designate identical, similar, or mutually corresponding elements. Elements in the figures shown are not necessarily shown to scale. Rather, the different elements shown in the figures are reproduced in such a way that their function and general purpose are understandable to the person skilled in the art. Connections and couplings between functional units and elements shown in the figures can, unless explicitly stated otherwise, also be implemented as an indirect connection or coupling. Functional units, in particular the sensing system and its components, can be implemented in particular as hardware, software, or a combination of hardware and software.

FIG. 1 schematically illustrates a first exemplary calibration and operation scenario 100. An operation of a target system via a user interface UI thereof is to take place from a vehicle 105, in which an occupant of the vehicle performs a user input with respect to the UI in a contactless manner, i.e. without physically coming into contact with the target system. The vehicle 105 comprises for this purpose a sensing system 110 having a sensor 115 coupled thereto for signaling, in particular having an image sensor (such as a camera, in particular a video camera). The sensing system 110 can in particular be a program-controlled data processing device configured and programmed to receive sensor data supplied by the sensor 115 and process these data in the context of the method from FIG. 4 (and possibly the method from FIG. 6). By means of the sensor 115, various user inputs can be detected which the user, in the present example the occupant, performs in the vehicle or out of the vehicle. Such user inputs can be executed in particular by means of one or more free space gestures, in particular pointing gestures, or by one or more targeted views (eye tracking) and detected by the sensor 115.

In the example shown in FIG. 1, the vehicle occupant as the user executes a pointing gesture 140 as a contactless free space gesture. The pointing direction corresponds here to a direction of the user input which can therefore be referred to as a “directed” user input, since a specific detected direction is assigned thereto as a whole or in a time-dependent manner, i.e. in each case for specific points of time during its execution. It is illustrated in FIG. 1 on the basis of a virtual direction beam 145. A separate reference system, in particular coordinate system, 120 can be assigned to the vehicle 105. This coordinate system 120 can optionally already be defined as the first reference system. It can in particular be a Cartesian, in particular right-hand, coordinate system having coordinate axes x, y, and z, as illustrated. However, another variant is described hereinafter, in which a coordinate system 120a shifted in relation to the coordinate system 120 along the Y axis is selected as the “first” coordinate system.

The target system can in particular be a stationary infrastructure device, such as a parking meter, a barrier system, an ordering kiosk at a drive-in business or restaurant, or a car wash facility. Many other applications or target systems are also conceivable. In the example of FIG. 1, the target system has a display device 130 in the form of a display screen having planar display surface. This display surface is assigned a second reference system 135, in particular a coordinate system, so that two axes of the coordinate system extend parallel to the display surface or even lie thereon. It can also in particular be a Cartesian coordinate system here, having coordinate axes x′, y′, and z′, as illustrated. The coordinates can in particular be scaled with respect to the display screen size.

Since the relative location of the vehicle 105 in relation to the target system and therefore in relation to the second reference system 135 is typically variable and is moreover not known a priori due to the mobility of the vehicle 105, the relative location of the two reference systems 120 and 135 is also typically variable and is not known beforehand, i.e. before execution of a calibration method.

In order to be able to perform a transformation H of a user input 140 detected by the vehicle-based sensor 115, which is thus anchored in the reference system 120, into the second reference system of the target system, with the aid of the sensing system 110, the sensing system 110 has to be calibrated. This transformation is therefore initially determined before user inputs can then be reliably performed thereafter on the basis of the calibration.

To determine the transformation H, a first virtual surface 125 anchored in the reference system 120 and a second virtual surface anchored in the second reference system 135, which coincides in the present example with the display surface of the display screen 130, are defined. For reasons of simpler computability of the transformation, it is expedient in this case if both virtual surfaces 125 and 130 are each planar, thus virtual planes or delimited sections thereof.

A second exemplary calibration and operation scenario 200 expanded in relation thereto is illustrated in FIG. 2. This figure largely corresponds to FIG. 1, wherein, however, the first virtual surface is divided into two separate partial surfaces 125a and 125b, which are each planar and are at an angle in relation to one another (first virtual plane and a third virtual plane different therefrom). In this way, the spatial area into which direction beams of the user input 140 can point so that they hit the first virtual surface and therefore one of the two partial surfaces 125a and 125b in an intersection point 150, can be expanded, in particular beyond the half space defined by a single planar partial surface. The second partial surface 125b is in turn assigned a separate reference system, in particular a Cartesian or other coordinate system 155 having coordinates x″, y″, z″, expediently in the case of a planar partial surface so that two axes of this reference system extend parallel to or in the second partial surface 125b.

The first partial surface 125 can also comprise more than two partial surfaces and/or in particular can also be curved, for example, into a spatially closed form surrounding the vehicle or the user, for example, in sphere form or a section thereof.

FIG. 3A perspectively illustrates by way of example a relative location of the two virtual planes 125 and 130 according to the example from FIG. 1. The user executes a moving user input here, during which they contactlessly copy a recognition pattern 310 displayed on the display device 130 in the form of a polyline-shaped path (approximately “Z”-shaped here by way of example) having the vertices V₁ to V₄. The copying can in particular take place so that the user points sequentially in discrete steps individually at the vertices V₁ to V₄, or continuously “travels along” the path.

Due to the generally different position and orientation of the two virtual planes 125 and 130, a distortion regularly results between the recognition pattern 310 and an input pattern 305 corresponding thereto, which is defined in the first virtual surface (plane) 125 by the discrete or continuous sequence of the intersection points of the direction beams 145 (only two of these are shown by way of example) during the performance of the user input. The relative location of the vertices V′1 to V′4 corresponding to the vertices V₁ to V₄ of the recognition pattern therefore generally differs due to the distortion from the relative location of the vertices V₁ to V₄ in relation to one another.

FIG. 3B once again shows the recognition pattern 310 and the input pattern 305 corresponding thereto on a common representation plane transferred in terms of a comparison 301, so that the effect of the distortion is well visible.

In order to be able to ensure correct user inputs with respect to a defined user interface UI of the target system with respect to the display surface 130, it is therefore necessary to determine the above-mentioned transformation H in the context of the calibration, in particular to calculate or estimate it, so that it compensates for this distortion at least in a good approximation.

A calibration method 400 suitable for this purpose is illustrated in FIG. 4 as an exemplary embodiment. The method 400, which is explained hereinafter with additional exemplary reference to FIGS. 1, 3, and 5, comprises a process 405 in which sensor data are received from the sensor 115 by the sensing system 110. In contrast, if the sensor 115 is counted as a component of the sensing system 110, the process 405 thus corresponds to generating the sensor data by the sensing system 110 including its sensor 115 itself.

The sensor data are related to the reference system 120 or already the reference system 120a and describe therein an input pattern 305 detected by the sensor 115, which the user generates by means of the contactless directed user input 140. This takes place in that, as illustrated in FIG. 3, they copy a linear, in particular polyline-shaped (chain made up of straight segments), path displayed on the display device 130 as the recognition pattern 310 with their user input 140, in particular travel along it or track it by sequentially pointing at the vertices in a sequence defined by the course of the path. The intersection points of direction beams of the user input with the first virtual plane 125 are determined, which in turn define the input pattern 305 as a line or path on the first virtual plane 125.

Typically, the input pattern 305 will only approximately correspond to the recognition pattern 310 here, in particular already because contactless directed user inputs, such as free space gestures or eye movements that can be sensed via eye tracking in particular, are not exactly controllable by the user themself and therefore per se naturally have variations or are subject to tolerances.

FIG. 5 illustrates, in the context of an illustration 500 for the determination of partial patterns, an exemplary course of a path-shaped input pattern 305, as a user could input according to their user input 140 when traveling along a path-shaped recognition pattern 310, displayed on a display screen 130 of the target system, having the vertices V1 to V4. The input pattern 305 is similar here to the polyline-shaped recognition pattern 310 constructed from straight segments, but does not exactly correspond thereto. In order to improve the quality of the further calibration to be determined, in a further process 410 in the scope of the method 400 (cf. FIG. 4), the input pattern 305 is therefore straightened. This can in particular be carried out by means of a so-called Hough transformation, as is known from the field of image processing. As a result of this straightening, a polyline-shaped path formed from straight linked segments results as a straightened input pattern 305a on the virtual plane 125.

Proceeding from the straightened input pattern 305a, in a further process 415 of the method 400, N different partial patterns Pᵢ with i=1, . . . , N, with N>1, in the present example especially path sections, are now determined. Each of the path sections Pᵢ represents a part of the input pattern 305a in the sense of a subset of the points thereof and can in particular comprise multiple interlinked straight segments of the input pattern 305a. An exemplary result of the process 415 for the case N=3 is illustrated in the lower part of FIG. 5, wherein each path section has the same number M of vertices as the recognition pattern 310. In the present example, M=4 thus applies.

In the further course of the method 400, processing of the defined path sections Pᵢ then takes place, which can be carried out, for example, in the form of a looped processing process, which is initialized in a process 420 by setting a loop index i with i:=1. In the context of each loop pass, on the basis of the recognition pattern 310, which is identical here for all loop passes, and the respective partial pattern or path section Pᵢ, a mapping rule, in particular a homography, Hᵢ is calculated or estimated between the first coordinate system 120 and the second coordinate system 135 in a process 425.

One possibility for calculating Hᵢ will now be explained in more detail on the basis of a simple example, wherein reference is made in particular to FIGS. 1 and 3A and 3B.

At a specific point in time, the vehicle 105 is positioned so that the display screen 130 is located to the front right from the user (for example, the driver). In the second coordinate system 135 of the display screen 130, the vertices V₁ to V₄ of the recognition pattern 310 occupy the following coordinates (x′, y′, and z′) by way of example: Vertex V₁=(0, 0, 1); vertex V₂=(1, 0, 1), vertex V₃=(0, 0, 0), and vertex V₄=(1, 0, 0). It is to be noted that this information is unknown to the sensing system 110, because of which a calibration is required. Since all vertices V₁ to V₄ lie on the display screen plane, they all have the y coordinate “0” in the coordinate system 135 of the display screen 130.

The sensing system 110 uses as the virtual plane {(x, 1, z): x, z∈ [symbol] } a plane lying orthogonal to the y axis and placed here by way of example one length unit “1” (for example, 1 m) in the y direction in front of the origin (cf. FIG. 1).

This plane is selected here as the first virtual plane 125 and can be provided with its own two-dimensional coordinate system 120a, which is given by (x,z)_{E}:=(x, 1, z)_{F}, wherein the suffix “F” indicates the vehicle-based coordinates of the coordinate system 120 and the suffix “E” indicates the coordinates of the virtual plane 125. In this case, the coordinates (x,z)_{E} of the plane 125 are thus simply the x and z components of the vehicle-based coordinates.

The sensing system 110 now calculates, on the basis of the dedicated directed user inputs with respect to the vertices V₁ to V₄ of the recognition pattern 310, the coordinates with respect to the coordinate system 120a of the vertices V′₁ to V′₄ of the input pattern 305 corresponding to the vertices V₁ to V₄ as the intersection points of the direction beams 145 corresponding to the user inputs with the first virtual plane 125 (cf. FIG. 3). In the present example, the coordinates of the vertices V′₁ to V′₄ thus determined are as follows: V′₁: (0.5; 0.5)_{E}; V′₂: (2; 1)_{E}; V′₃: (0.5; 0)_{E}; and V′₄: (2; 0)_{E}. This is illustrated in FIG. 3B.

The projection made in the example models the following assumption: When pointing at the display screen or the second plane 130, the user, visually speaking, holds the arm extended and their shoulder lies in the coordinate origin of the coordinate system 120. All pointing beams thus start in the coordinate origin, and a perspective projection on the virtual plane 125 results, which is obtained in that each point in 3D, toward which the user points, is projected in the direction of the coordinate origin on the virtual plane 125. That the shoulder here is in particular in the origin and not at another point is only an arbitrary selection mathematically speaking, but it facilitates the calculations in this example somewhat.

A mapping rule, specifically a homography Hᵢ here, is now to be determined so that in the scope of a specific tolerable accuracy, which can be determined in particular by the measurement accuracy of the sensor 115 and/or a quality of the user input 140, the following applies:

$$( \begin{matrix}{X}_{k} \\ {Y}_{k} \\ {Z}_{k}\end{matrix} ) ∼ {H}_{i} \cdot ( \begin{matrix}{X}_{k}^{′} \\ {Y}_{k}^{′} \\ {Z}_{k}^{′}\end{matrix} ) for all k . \qquad ( 1 )$$

In this case, Vₖ=(Xₖ; Yₖ; Zₖ); with k=1, . . . , 4, are the coordinates of the vertices Vₖ in the second reference system 135 and V′ₖ=(X′ₖ; Y′ₖ; Z′ₖ) are the coordinates of the vertices V′ₖ corresponding thereto in the reference system 120.

The tilde “˜” in the equations means “multiples of one another”. Accordingly, an equation v˜w (for vectors v and w) thus expresses: “There is an x in [symbol] , so that v=x·w or x·v=w. (Leaving the x on both sides is only necessary for the case that one of the vectors is 0). The factor “x” is not to be confused here with the coordinate “x” of the coordinate system 120 introduced above.

The homography Hᵢ is thus ultimately a mapping between two-dimensional spaces, thus from [symbol] ² to [symbol] ² or, visually speaking, from the virtual plane 125 to the display screen plane 130 (thus in FIG. 3B from the left side to the right side, so that the left distorted quadrangle is mapped with correct perspective on the right quadrangle).

The homography Hᵢ is uniquely determined and can be calculated (or estimated) when at least four vertices are present on each side (=requirements for the recognition pattern 310). Therefore, the homography Hᵢ can be determined by solving the following equation system on the basis of the above-mentioned coordinates for the vertices V₁ to V₄ and V′₁ to V′₄:

$${H}_{i} \cdot ( \begin{matrix}0.5 \\ 0.5 \\ 1\end{matrix} ) \sim ( \begin{matrix}1 \\ 0 \\ 1\end{matrix} ) ; {H}_{i} \cdot ( \begin{matrix}2 \\ 1 \\ 1\end{matrix} ) \sim ( \begin{matrix}1 \\ 1 \\ 1\end{matrix} ) ; {H}_{i} \cdot ( \begin{matrix}0.5 \\ 0 \\ 1\end{matrix} ) \sim ( \begin{matrix}0 \\ 0 \\ 1\end{matrix} ) ; {H}_{i} \cdot ( \begin{matrix}2 \\ 0 \\ 1\end{matrix} ) \sim ( \begin{matrix}0 \\ 1 \\ 1\end{matrix} ) . \qquad ( 2 )$$

This linear equation system can be solved in a routine manner using standard methods of matrix calculation, from which a matrix (Hᵢ) representing the homography Hᵢ results as:

$$( {H}_{i} ) = ( \begin{matrix}0 & 3 & 0 \\ 2 & 0 & - 1 \\ 1 & 0 & 1\end{matrix} ) \qquad ( 3 )$$

The following is also to be noted in this regard:
a) While the homography Hᵢ itself (i.e. the mapping rule) between the planes is uniquely determined by the four point correspondences, the homography matrix (Hᵢ) is only determined up to a scaling. Therefore, any scalar nonzero multiple of the above solution for (Hᵢ) would function similarly and result in the same mapping Hᵢ.
b) In this example, measurement errors, noise, etc. were not considered. Therefore, there is here an exact solution for Hᵢ or specifically (Hᵢ) which meets the boundary conditions according to equations (2). In a real scenario, however, only a suitable or even optimal approximation solution would usually be able to be found in consideration of the projection error instead of an exact solution, for example by estimating.

Referring once again to FIG. 4, the process 425 is followed by a further process 430, in which a mapping error Ei between the (not straightened) current path section Pᵢ and the recognition pattern 310 is determined. This can be carried out in particular as follows on the basis of the ordered sequence of the vertices V₁ to V_{M} of the recognition pattern 310, on the one hand, and the correspondingly ordered sequence of the M vertices c′₁ to c′_{M} of the path section Pᵢ following one another along the course of the path section Pᵢ, on the other hand:

$${E}_{i} = {\sum }_{q = 1}^{M} {( π ( {H}_{i} ( {c}_{q}^{′} ) ) - π ( {V}_{q} ) )}^{2} \qquad ( 4 )$$

Hᵢ(c_{q}) is the matrix product of the coordinate vector to c′_{q} with (Hᵢ). The further mapping π: [symbol] ³→ [symbol] ² designates a homogeneous projection

$$π ( {c}_{x} ; {c}_{y} ; {c}_{z} ) = ( \frac{{c}_{x}}{{c}_{z}} ; \frac{{c}_{y}}{{x}_{z}} )$$

for generating homogeneous (scaled here with respect to the Z direction) coordinates.

In a step 435, the index i is then incremented and it is then checked in a process 440 whether a further loop pass is necessary. If this is the case (440—no), a further loop pass is thus run with the processes 425-440. Otherwise (440—yes), the path section Pᵢ is selected among the path sections which has the smallest mapping error Eⱼ among all path sections Pᵢ. Finally, in a further process 450, the mapping rule or homography H:=Hⱼ corresponding to the selected path section Pj is defined as the calibration variable for calibrating the sensing system 110 for subsequent user inputs with respect to the UI of the target system.

An exemplary method 600 for sensing such user inputs is illustrated in FIG. 6. The method 600 can be carried out when the calibration method 400 has been completed beforehand. In this case, comparably to the reception or generation of sensor data in the process 405 of the method 400, input data are received or generated with the aid of the sensor 115 in a process 605. The input data in this case represent, in the reference system 120 or already transferred into the first reference system 120a, an arbitrary contactless directed user input sensed by the sensing system, which the user executes with respect to the UI of the target system.

In a further process 610, these input data are transformed into the second reference system 135 using the calibration variable (mapping rule H) originating from the calibration method 400 in order to obtain corresponding output data, which represent the user input in the second reference system or coordinate system 135 of the target system.

In a yet further process 620, these output data are transmitted to the target system, in particular to an interface unit thereof, in order to thus control, operate, or configure the target system in dependence on the user input.

While at least one exemplary embodiment has been described above, it has to be noted that there are a large number of variations in this respect. It is also to be noted here that the described exemplary embodiments constitute only non-limiting examples and they are not intended to limit the scope, applicability or configuration of the devices and methods described here. Instead, the above description will provide a person skilled in the art with an indication for the implementation of at least one exemplary embodiment, wherein it is understood that various changes in the means of functioning and the arrangement of the elements described in an exemplary embodiment can be made without departing here from the subject matter which is respectively defined in the appended claims or its legal equivalents.

LIST OF REFERENCE SIGNS

| | |
|---|---|
| V₁-V₄ | vertices of the recognition pattern |
| V′₁-V′₄ | vertices of the input pattern |
| 100 | first exemplary calibration and operation scenario |
| 105 | vehicle, in particular motor vehicle |
| 110 | sensing system |
| 115 | sensor for detecting contactless directed user inputs |
| 120 | vehicle-related reference system or coordinate system |
| 120a | first reference system or coordinate system for the plane 125 |
| 125 | first virtual surface, in particular virtual plane |
| 125a, b | (planar) partial surfaces of the first virtual surface |
| 130 | second virtual plane, also real display screen of a target system |
| 130a | second partial surface of the second virtual plane, also real display screen |
| | of a target system |
| 135 | second reference system or coordinate system |
| 140 | user input, in particular free space gesture, for example, pointing gesture |
| 145 | (virtual) direction beam(s) of the directed user input 140 |
| 150 | intersection point of the direction beam 145 with the first plane 125 |
| 155 | third reference system or coordinate system |
| 160 | second partial surface of the second virtual plane, also projection surface |
| | of a projector of the target system |
| 200 | second exemplary calibration and operation scenario |
| 300 | spatial relationship of input pattern and recognition pattern |
| 301 | comparison of input pattern and recognition pattern |
| 305 | input pattern, path-shaped |
| 310 | recognition pattern, path-shaped |
| 400 | calibration method |
| 405-450 | partial processes of the calibration method |
| 500 | determination of partial patterns |
| 600 | method for sensing user inputs |
| 605-615 | partial processes of the method 600 |
| Pᵢ | partial patterns or path sections of the input pattern 225 |
| x, y, z | coordinates of the first reference system 120 or the first partial surface 125a |
| x′, y′, z′ | coordinates of the second reference system 135 |
| x″, y″, z″ | coordinates of the second partial surface 125b |

1. A calibration method for calibrating a sensing system for sensing contactless directed user inputs of a user with respect to a user interface (UI) of a target system, wherein the method comprises:
receiving or sensor-based generating sensor data, which represent a sensorially detected input pattern with respect to a first reference system assigned to the sensing system, that a user inputs by at least one contactless directed user input with respect to the UI, in order to copy a structure of a predefined recognition pattern visually represented by a display device of the UI by a spatial course of the user input, wherein the display device is assigned a second reference system;
determining two or more different partial patterns of the input pattern;
for each of the partial patterns:
determining a mathematical mapping rule assigned to the partial pattern between the two reference systems and mapping the partial pattern or the recognition pattern on the basis of the mapping rule so that after the mapping, the partial pattern and the recognition pattern exist in a common reference system,
determining a mapping error, which indicates a measure of a deviation between the partial pattern and the recognition pattern in the common reference system, and
selecting one of the partial patterns in dependence on a comparison of its assigned mapping error to the respective mapping error of at least one other partial pattern; and
defining the mapping rule assigned to the selected partial pattern as a calibration variable for calibrating the sensing system for a subsequent use for transformation of contactless directed user inputs of the user sensed with respect to the first reference system into user inputs corresponding thereto with respect to the UI of the target system in relation to the second reference system.

2. The calibration method as claimed in claim 1, wherein the calibration method is configured or used to calibrate a sensing system arranged in or on a vehicle with respect to a vehicle-external target system in relation to this vehicle.

3. The calibration method as claimed in claim 1, wherein the sensor-based generation of sensor data is carried out by sensorial detection of a free space gesture of the user or by head or eye tracking.

4. The calibration method as claimed in claim 1, wherein:
the input pattern represents a sensorially detected path, which a user inputs by the at least one contactless directed user input with respect to the UI, in order to copy a structure in the form of a course of a predefined polyline-shaped recognition pattern visually displayed by a display device of the user interface by a spatial course of the user input; and
at least two of the partial patterns of the input pattern each represent a different path section of the overall path.

5. The calibration method as claimed in claim 4, furthermore comprising:
smoothing the path before determining the path sections as partial patterns.

6. The calibration method as claimed in claim 5, wherein the smoothing of the path comprises straightening the path section by section, in which the path is approximated by a plurality of respectively straight segments.

7. The calibration method as claimed in claim 6, wherein the straightening of the path section by section is carried out using a Hough transformation.

8. The calibration method as claimed in claim 1, wherein:
the first reference system is defined as a first virtual two-dimensional surface or such a surface is defined therein;
the input pattern on the first virtual surface is defined by a linear beam-shaped projection of the user input, following the respective current direction of the directed user input along its spatial course, on the first virtual surface;
the second reference system is defined as a second virtual surface; and
for each partial pattern, the associated mapping rule defines a mapping between the two virtual surfaces, wherein the one of the surfaces which is used as the target surface of the mapping rule is defined as the common reference system.

9. The calibration method as claimed in claim 8, wherein the first reference system is defined in dependence on one or more previously detected directed user inputs so these one or more previously detected user inputs correspond to points and/or lines on the first virtual surface.

10. The calibration method as claimed in claim 8, wherein at least one of the two surfaces is defined so that it comprises a virtual plane or a delimited surface section thereof.

11. The calibration method as claimed in claim 10, wherein the first virtual surface is defined so that it comprises a virtual plane or a delimited surface section thereof, which is orthogonal to the direction of a previously detected directed user input.

12. The calibration method as claimed in claim 8, wherein the first virtual surface is defined so that it meets at least one of the following conditions:
the first virtual surface forms a boundary surface, which encloses a three-dimensional spatial area on at least two sides;
the first virtual surface comprises at least two separate partial surfaces, which are nonparallel at least in some sections;
each linear beam-shaped projection of a directed user input along its respective current direction through the first virtual surface intersects the first virtual surface in precisely one point.

13. The calibration method as claimed in claim 1, wherein the partial patterns are determined so that they are each at least proportionally represented by a sequence of discrete points on the input pattern.

14. The calibration method as claimed in claim 1, further comprising:
determining the respective mapping error of a partial pattern based on a comparison of the recognition pattern with the partial pattern in the common reference system on the basis of homogeneous coordinates is used to describe the recognition pattern, on the one hand, and the partial pattern, on the other hand.

15. A method for sensing contactless directed user inputs of a user with respect to a user interface (UI) of a target system by a sensing system, wherein the method comprises:
calibrating the sensing system according to the calibration method according to claim 1;
receiving or sensor-based generating input data, which represent a sensorially detected contactless directed user input of a user with respect to the UI in the first reference system;
transforming the input data into output data, which represent an input at the UI, corresponding to the user input and transformed into the second reference system, using the mapping rule determined in the context of the calibration method or a mapping rule inverse thereto; and
transmitting the output data to the target system.

16. A sensing system for sensing contactless directed user inputs of a user with respect to a user interface (UI) of a target system, wherein the sensing system is configured to carry out the calibration method as claimed in claim 1.

17. The sensing system as claimed in claim 16, furthermore comprising a sensor device for sensorially detecting the contactless user inputs and for generating sensor data and/or input data, which represent these user inputs in the first reference system.

18. A vehicle comprising a sensing system as claimed in claim 17.

19. A non-transitory computer-readable medium comprising instructions which, when they are executed on one or more processors of a sensing system as claimed in claim 16, prompt it to carry out a calibration method comprising:
receiving or sensor-based generating sensor data, which represent a sensorially detected input pattern with respect to a first reference system assigned to the sensing system, that a user inputs by at least one contactless directed user input with respect to the UI, in order to copy a structure of a predefined recognition pattern visually represented by a display device of the UI by a spatial course of the user input, wherein the display device is assigned a second reference system;
determining two or more different partial patterns of the input pattern;
for each of the partial patterns:
determining a mathematical mapping rule assigned to the partial pattern between the two reference systems and mapping the partial pattern or the recognition pattern on the basis of the mapping rule so that after the mapping, the partial pattern and the recognition pattern exist in a common reference system,
determining a mapping error, which indicates a measure of a deviation between the partial pattern and the recognition pattern in the common reference system, and
selecting one of the partial patterns in dependence on a comparison of its assigned mapping error to the respective mapping error of at least one other partial pattern; and
defining the mapping rule assigned to the selected partial pattern as a calibration variable for calibrating the sensing system for a subsequent use for transformation of contactless directed user inputs of the user sensed with respect to the first reference system into user inputs corresponding thereto with respect to the UI of the target system in relation to the second reference system.
